(19) United States
(12) Patent Application Publication
(10) Pub. No.: US 2025/0179095 A1
(43) Pub. Date: Jun. 5, 2025

(54) SULFONIC ACID-FUNCTIONALIZED COPPER METAL-ORGANIC FRAMEWORK AND PREPARATION METHOD AND USE THEREOF

(71) Applicant: Nanchang Hangkong University, Nanchang City (CN)

(72) Inventors: Lin DING, Nanchang City (CN); Xubiao LUO, Nanchang City (CN); Qiang WANG, Nanchang City (CN); Pengxiang WANG, Nanchang City (CN); Wei REN, Nanchang City (CN)

(21) Appl. No.: 18/905,405

(22) Filed: Oct. 3, 2024

(30) Foreign Application Priority Data
Dec. 5, 2023 (CN) 202311650959.5

(51) Int. Cl. C07F 1/00; C01B 39/48

(52) U.S. Cl. CPC C07F 1/005; C01B 39/48; C01P 2002/72; C01P 2002/74

(57) ABSTRACT

Provided are a sulfonic acid-functionalized copper metal-organic framework (HKUST-1 (SO₃H)), and a preparation method and use thereof. The HKUST-1 (SO₃H) is prepared by using a strongly acidic copper-containing industrial wastewater as a raw material, and trimesic acid (BTC) and 5-sulfoisophthalic acid monosodium salt as ligands, and introducing a sulfonic acid group before synthesis, thereby obtaining the HKUST-1 (SO₃H).

### CROSS REFERENCE TO RELATED APPLICATION

This patent application claims the benefit and priority of Chinese Patent Application No. 202311650959.5 filed with the China National Intellectual Property Administration on Dec. 5, 2023, the disclosure of which is incorporated by reference herein in its entirety as part of the present application.

### TECHNICAL FIELD

The present disclosure belongs to the technical field of porous material preparation, and specifically relates to a sulfonic acid-functionalized copper metal-organic framework (HKUST-1 (SO₃H)), and a preparation method and use thereof.

### BACKGROUND

Metal-organic frameworks (MOFs) are a type of network skeleton material with porous structure, large specific surface area, and regular crystal structure, which are generated by combining metal ions (components of nodes) and multiphase organic ligands (structural connectors) through coordination chemistry. Compared with traditional porous materials, the MOFs have a porosity of up to 90% and a specific surface area of greater than 6,000 m²/g. Moreover, the structure of the MOFs could be adjusted by controlling the pore size and the type of organic ligands. Therefore, MOFs exhibit excellent performance and have broad application and research prospects in fields such as hydrogen storage, drug carriers, catalysis, fluorescence, biosensors, gas adsorption and separation, and supercapacitors.

Copper metal-organic framework (HKUST-1) is an important type of the MOFs. In an existing preparation method, a sulfonic acid-functionalized HKUST-1 composite is prepared by steps of preparing HKUST-1 from raw materials of a copper salt and trimesic acid (BTC), activating the HKUST-1 to remove coordinated water, activating aminosulfonic acid and then mixing activated aminosulfonic acid and the HKUST-1 to obtain a mixture, subjecting the mixture to reflux reaction to obtain a reaction product, and heat-treating the reaction product in a muffle furnace to obtain the sulfonic acid-functionalized HKUST-1 composite. However, this method has complicated steps.

### SUMMARY

The present disclosure aims to provide an HKUST-1 (SO₃H), and a preparation method and use thereof. In the present disclosure, the preparation method allows synthesis of the HKUST-1 (SO₃H) in a copper-containing wastewater by a one-step process, and has simple steps and a low cost.

To achieve the above objects, the present disclosure provides the following technical solutions:

The present disclosure provides a method for preparing an HKUST-1 (SO₃H), including the following steps:
(1) providing a copper-containing wastewater with a copper ion concentration of not less than 6 g/L; and
(2) mixing the copper-containing wastewater, anhydrous ethanol, trimesic acid (BTC), 5-sulfoisophthalic acid monosodium salt (5-SSIPA), and N,N-dimethylformamide (DMF) to obtain a mixture, and subjecting the mixture to coordination polymerization to obtain the HKUST-1 (SO₃H).

In some embodiments, the coordination polymerization is conducted at a temperature of 75° C. to 85° C. for 20 h to 24 h.

In some embodiments, a molar ratio of the BTC to the 5-SSIPA is in a range of 2-10: 0-8, excluding 0.

In some embodiments, a molar ratio of copper ions in the copper-containing wastewater to the BTC is in a range of 3.85-19.23:1.

In some embodiments, the copper-containing wastewater has the copper ion concentration of not less than 15 g/L.

In some embodiments, a volume ratio of the copper-containing wastewater to the anhydrous ethanol is in a range of 1: 1-1.5.

In some embodiments, a volume ratio of the copper-containing wastewater to the DMF is in a range of 2-10: 1-3.

The present disclosure further provides an HKUST-1 (SO₃H) prepared by the method as described in the above solutions having a molecular formula of C₁₈H₁₀O₁₆N₃Cu₃S.

In some embodiments, the HKUST-1 (SO₃H) has an average pore size of 9.2 nm to 10.61 nm.

The present disclosure further provides use of the HKUST-1 (SO₃H) in waste resource treatment, gas adsorption and separation, dyes, and antibiotic degradation.

The present disclosure provides a method for preparing an HKUST-1 (SO₃H), which has simple steps and easy operation, thus greatly reduces a production cost of HKUST-1, and thereby exhibits obvious environmental and economic benefits. In the present disclosure, the HKUST-1 (SO₃H) is prepared by using a strongly acidic copper-containing industrial wastewater as a raw material, and BTC and 5-SSIPA as ligands, and introducing a sulfonic acid group before synthesis to achieve dual-ligand functionalization of MOFs, thereby obtaining the HKUST-1 (SO₃H). The sulfonic acid group improves a structural stability and also increases an electrostatic interaction with cations in polluted water, such that the HKUST-1 (SO₃H) shows a high selective adsorption performance, a strong adsorption capacity, a low preparation cost, and a higher performance added value.

Strongly acidic copper-containing industrial wastewater shows highly toxic, has a low pH value, and is seriously harmful to humans. In addition, it is difficult to recover copper ions from the strongly acidic copper-containing industrial wastewater, due to engineering science problems such as long process, low selectivity, and heavy secondary pollution. The present disclosure proposes an economical and environmental-friendly strategy, which not only effectively removes heavy metal ions from the strongly acidic copper-containing industrial wastewater, but also produces the HKUST-1 (SO₃H) with relatively great application values. In the present disclosure, low-cost, high-value-added MOFs are developed in situ in combination with the water quality characteristics of strongly acidic copper-containing industrial wastewater. Cu²⁺ is selectively recycled from the strongly acidic copper-containing industrial wastewater and serves as a metal source for high-value-added MOFs, providing a theoretical basis and technical support for the selective separation and directional recycling of copper ions in the strongly acidic copper-containing industrial wastewater. At the same time, the synthesized MOFs are used for adsorption of heavy metals, especially toxic heavy metals such as lead ions, realizing “waste treatment with waste”.

The present disclosure further provides an HKUST-1 (SO₃H) prepared by the method as described in the above solutions having a molecular formula of C₂₀H₂₆N₃O₆S. In the present disclosure, the sulfonic acid group is introduced into HKUST-1, improving the structural stability and increasing the electrostatic interaction with cations in polluted water. The obtained HKUST-1 (SO₃H) exhibits a high selectivity, a large adsorption capacity, and a low preparation cost.

The present disclosure further provides use of the HKUST-1 (SO₃H) in waste resource treatment, gas adsorption and separation, dyes, and antibiotic degradation. In the present disclosure, the HKUST-1 (SO₃H) exhibits a highly selective adsorption, has a strong adsorption capacity and a high performance added value, and is suitable for the treatment of heavy metal wastewater, particularly suitable for the treatment of lead ion wastewater, thus showing an important ecological value.

### BRIEF DESCRIPTION OF THE DRAWINGS

To describe the technical solutions in embodiments of the present disclosure or in the prior art more clearly, the accompanying drawings used in the examples are briefly described below. Apparently, the accompanying drawings in the following description show merely some embodiments of the present disclosure, and those of ordinary skill in the art may still derive other accompanying drawings from these accompanying drawings without creative efforts.

FIG. 1 shows a main process flow for preparing HKUST-1 (SO₃H) according to an embodiment of the present disclosure;

FIG. 2 shows X-ray diffraction (XRD) patterns of the HKUST-1 (SO₃H) prepared in Examples 2 to 6 of the present disclosure;

FIG. 3 shows Fourier transform infrared spectroscopy (FTIR) spectrums of the HKUST-1 (SO₃H) prepared in Examples 2 to 6 of the present disclosure;

FIG. 4 shows X-ray photoelectron spectroscopy (XPS) patterns of the HKUST-1 (SO₃H) prepared in Examples 2 to 6 of the present disclosure; and

FIG. 5 shows Pb²⁺ adsorption capacity of the HKUST-1 (SO₃H) prepared in Examples 2 to 6 of the present disclosure.

### DETAILED DESCRIPTION OF THE EMBODIMENTS

The present disclosure provides a method for preparing an HKUST-1 (SO₃H), including the following steps:
(1) providing a copper-containing wastewater with a copper ion concentration of not less than 6 g/L; and
(2) mixing the copper-containing wastewater, anhydrous ethanol, BTC, 5-SSIPA, and N,N-dimethylformamide (DMF) to obtain a mixture, and subjecting the mixture to coordination polymerization to obtain the HKUST-1 (SO₃H).

In some embodiments, the copper-containing wastewater provided has the copper ion concentration of not less than 6 g/L. In some embodiments, the copper-containing wastewater with the copper ion concentration of not less than 6 g/L is prepared by: either diluting (a strongly acidic copper-containing industrial wastewater with a copper ion concentration of higher than 15 g/L) by mixing the strongly acidic copper-containing industrial wastewater and water (referred to as a first mixing), or concentrating (a strongly acidic copper-containing industrial wastewater with a copper ion concentration of lower than 6 g/L).

In some embodiments, the strongly acidic copper-containing industrial wastewater has a pH value of −1 to 2, preferably 1. In some embodiments, the strongly acidic copper-containing industrial wastewater has copper ions as the metal ions with the highest concentration. In some embodiments, the strongly acidic copper-containing industrial wastewater is derived from industrial wastewater generated by production lines of copper pipes, copper rods, copper wires, copper strips, electromagnetic wires, valves, magnetic materials, and high-quality alloys. In some embodiments, the high-quality alloys include at least one selected from the group consisting of brass, bronze, red copper, and white copper. In a specific embodiment, the strongly acidic copper-containing industrial wastewater is derived from industrial wastewater produced by manufacturing enterprises of copper alloys and advanced materials in Ningbo.

In some embodiments, a volume ratio of the strongly acidic copper-containing industrial wastewater to water is in a range of 2-10: 13-65, preferably 3-9: 20-55, and more preferably 5-7: 30-45, and the water is deionized water. In a specific embodiment, the strongly acidic copper-containing industrial wastewater has a volume of 2 mL, 4 mL, 6 mL, 8 mL, or 10 mL, and the water has a volume of 13 mL, 26 mL, 39 mL, 52 mL, or 65 mL.

In some embodiments, the concentrating is conducted based on the copper ion concentration of the copper-containing wastewater being increased to not less than 6 g/L.

In some embodiments, the first mixing is ultrasonic mixing. In some embodiments, the ultrasonic mixing is conducted at a frequency of 28,000 Hz to 30,000 Hz, preferably 28,500 Hz to 29,500 Hz; and the ultrasonic mixing is conducted for 10 min to 15 min, and preferably 12 min to 14 min.

In some embodiments, a composition analysis for the strongly acidic copper-containing industrial wastewater is conducted before the diluting or concentrating. In some embodiments, the composition analysis includes: filtering the strongly acidic copper-containing industrial wastewater and subjecting a resulting filtrate to metal analysis, chemical oxygen demand (COD) analysis, and pH measurement. In some embodiments, the filtering is conducted by vacuum filtration, the metal analysis is conducted by atomic absorption spectrophotometry-flame atomic absorption, the COD analysis is conducted by a COD analyzer, and the pH measurement is conducted by a pH meter. Solid impurities could be removed through the filtering, ensuring the purity of the HKUST-1 (SO₃H). The metal ion content, COD content, and pH value of the strongly acidic copper-containing industrial wastewater are determined by the composition analysis, thus exploring the water quality conditions, and thereby determining the reasonable multiple of subsequent dilution.

In some embodiments, the atomic absorption spectrophotometry-flame atomic absorption includes: diluting the strongly acidic copper-containing industrial wastewater by 10,000 to 100,000 folds, diluting 10 folds each time, and diluting 4 to 5 times; sampling 2 times, and measuring each sample 2 times. The detection objects of the atomic absorption spectrophotometry-flame atomic absorption are mainly common heavy metal pollution ions.

In some embodiments, taking the test of copper ions as an example, a process for determining the concentration of copper ions includes: (i) preparing a standard solution of copper ions: adding 0.00 mL, 0.25 mL, 0.50 mL, 0.75 mL, or 1.00 mL of a 100 g/mL Cu standard solution into a 100 mL volumetric flask separately, diluting to a preset scale (i.e., 100 mL) with 1 mol/L dilute nitric acid, and shaking to be uniform; (ii) sampling the strongly acidic copper-containing industrial wastewater 2 times, filtering with a 0.22 μm filter head, diluting 10,000 folds in 4 times.

In some embodiments, the copper-containing wastewater has a copper ion concentration of not less than 6 g/L, preferably not less than 15 g/L, and more preferably 15 g/L to 30 g/L.

After the copper-containing wastewater is obtained, it is mixed with anhydrous ethanol, BTC, 5-SSIPA, and DMF (referred to as a second mixing) to obtain a mixture, and the mixture is subjected to coordination polymerization to obtain the HKUST-1 (SO₃H). In some embodiments, a volume ratio of the copper-containing wastewater to the anhydrous ethanol is in a range of 1: 1-1.5, preferably 1:1.1-1.4, and more preferably 1:1.2-1.3.

In some embodiments, a molar ratio of copper ions in the copper-containing wastewater to the BTC is in a range of 3.85-19.23:1, preferably 4.55-12.05:1, and more preferably 5.2:1; and the BTC has a chemical formula of C₉H₆O₆.

In some embodiments, a molar ratio of the BTC to the 5-SSIPA is in a range of 2-10: 0-8 excluding 0, preferably 4-8: 2-6, and more preferably 6-7: 3-5; the 5-SSIPA has a chemical formula of C₈H₅NaO₇S. In a specific embodiment, a molar ratio of the BTC to the 5-SSIPA is one selected from the group consisting of 10:0, 8:2, 6:4, 4:6, or 2:8.

In some embodiments, a volume ratio of the copper-containing wastewater to the DMF is in a range of 2-10: 1-3, preferably 3-8: 1-3, and more preferably 5-7: 2-3.

In some embodiments, the second mixing includes: premixing the anhydrous ethanol, the BTC, and the 5-SSIPA, mixing a resulting premixed solution and the copper-containing wastewater, and mixing a resulting mixed solution and the DMF; and the second mixing is conducted at room temperature under atmospheric pressure. The DMF is added to activate the crystal structure, physicochemical properties, and pore structure of the MOFs.

In some embodiments, the coordination polymerization is conducted at a temperature of 75° C. to 85° C., preferably 78° C. to 82° C., and more preferably 79° C. to 80° C., and the coordination polymerization is conducted for 20 h to 24 h, preferably 21 h to 23 h, and more preferably 22 h. In some embodiments, the coordination polymerization is conducted in a glass bottle or a reactor.

In some embodiments, after the coordination polymerization is completed, the preparation method further includes: drying and then grinding a resulting product, where the drying is conducted at a temperature of 40° C. to 50° C., preferably 42° C. to 48° C., and more preferably 44° C. to 46° C., and the drying is conducted for 20 h to 24 h, preferably 21 h to 23 h, and more preferably 22 h, and a target particle size of the grinding is in a range of 9 μm to 18 μm, and preferably 11 μm to 15 μm.

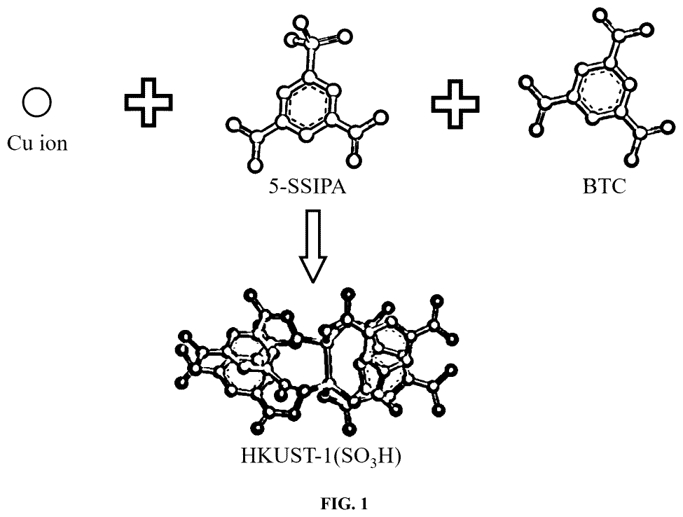

FIG. 1 shows a main process flow for preparing HKUST-1 (SO₃H) according to an embodiment of the present disclosure. The HKUST-1 (SO₃H) is prepared by coordination polymerization using BTC and 5-SSIPA as ligands and copper ions as cations.

The present disclosure further provides an HKUST-1 (SO₃H) prepared by the method as described in the above solutions, having a molecular formula of C₁₈H₁₀O₁₆N₃Cu₃S.

In some embodiments, the HKUST-1 (SO₃H) has an average pore size of 9.2 nm to 10.61 nm, preferably 9.4 nm to 10.2 nm.

The present disclosure further provides use of the HKUST-1 (SO₃H) in waste resource treatment, gas adsorption and separation, dyes, and antibiotic degradation.

In the present disclosure, the HKUST-1 (SO₃H) is prepared by using copper ions in wastewater, and the HKUST-1 (SO₃H) shows a high selective adsorption, a strong adsorption capacity, and a high performance added value. The HKUST-1 (SO₃H) could be used in aspects such as wastewater treatment and resource utilization, gas adsorption and separation, dyes, and antibiotic degradation, and is suitable for the treatment of heavy metal wastewater, especially suitable for the treatment of heavy metal ion wastewater, exhibiting important ecological values.

In order to further illustrate the present disclosure, the technical solutions of the present disclosure will be described in detail below in conjunction with accompanying drawings and examples, but these drawings and examples should not be understood as limiting the scope of the present disclosure.

### Example 1

Composition analysis of strongly acidic copper-containing industrial wastewater:

First, 1.0 L of the strongly acidic copper-containing industrial wastewater (Ningbo) was filtered, and a resulting solid residue was removed to obtain a filtrate, and then the filtrate was subjected to metal analysis, COD analysis, and pH measurement:

(1) Atomic absorption spectrophotometry-flame atomic absorption: the strongly acidic copper-containing industrial wastewater was diluted 100,000 folds, 10 folds each time, 5 times, to obtain copper-containing wastewater; sampling was conducted 2 times, and each sample was tested 2 times. Taking copper ions as an example, a process for determining the concentration of Cu²⁺ was conducted as follows: a standard solution of copper ions was prepared: in a 100 mL volumetric flask, 0.00 mL, 0.25 mL, 0.50 mL, 0.75 mL, and 1.00 mL of 100 g/mL Cu standard solution was added separately, and then diluted to a preset scale (i.e., 100 mL) with 1 mol/L dilute nitric acid, and then shaken to be uniform to obtain a copper-containing wastewater. The copper-containing wastewater was sampled 2 times, filtered with a 0.22 μm filter head, and diluted 10,000 folds in 4 times.

(2) Directly measuring the pH value of the strongly acidic copper-containing industrial wastewater with a pH meter: 0.5 L of the strongly acidic copper-containing industrial wastewater was placed in a beaker; the pH meter was calibrated and then immersed in the strongly acidic copper-containing industrial wastewater, and then the reading was taken on a display.

(3) COD analysis-potassium dichromate method: the COD of the strongly acidic copper-containing industrial wastewater was directly measured by using a COD analyzer. A measurement principle of the COD analyzer was as follows: in an acidic medium of sulfuric acid, potassium dichromate was used as an oxidant, silver sulfate was used as a catalyst, and mercuric sulfate was used as a masking agent for chloride ions; in a digestion reaction, the acidity of liquid sulfuric acid was 9 mol/L, and a digestion reaction solution was heated to boil, where a boiling point temperature of 148° C.±2° C. served as a digestion temperature; the digestion reaction was conducted by heating for 2 h with water as a cooling reflux; after the digestion solution was cooled naturally, the remaining potassium dichromate was titrated by using an ammonium ferrous sulfate solution, with Ferroin as an indicator. A COD value of the water sample was calculated based on a consumption of the ammonium ferrous sulfate solution.

The ion concentration of the strongly acidic copper-containing industrial wastewater was obtained by composition analysis of the strongly acidic copper-containing industrial wastewater. The results are shown in Table 1.

TABLE 1
Concentrations of various ions in the strongly
acidic copper-containing industrial wastewater

| Ion type | Ion concentration (g/L) |
|---|---|
| Cu²⁺ | 213.7 |
| Co²⁺ | 0.01584 |
| Ni⁺ | 1.144 |
| Zn²⁺ | 0.3154 |
| Fe²⁺/Fe³⁺ | 3.634 |
| Na⁺ | 98.3 |
| Mg²⁺ | 0.1034 |
| Cr³⁺/Cr⁶⁺ | 0.055 |

The strongly acidic copper-containing industrial wastewater has a pH of −0.87 and a COD of 2×10−3 g/L.

According to Table 1 and the above test results, it can be seen that the strongly acidic copper-containing industrial wastewater shows strongly acidic, has a high COD, complex composition, and many metal ion components, and is rich in copper ions. The top three metal ions in content are copper (213.7 g/L), sodium (98.3 g/L), and iron (3.634 g/L).

### Example 2

Synthesis of HKUST-1 (SO₃H) (a Molar Ratio of the BTC to 5-SSIPA being 10:0):

4 mL of the strongly acidic copper-containing industrial wastewater was diluted with 26 mL of deionized water to obtain a copper-containing wastewater. 0.68 g of BTC (a molar ratio of the BTC to 5-SSIPA being 10:0) was added into 30 mL of anhydrous ethanol (a volume ratio of the ethanol to the diluted wastewater being 1:1), and then dissolved through ultrasound. After that, a resulting solution was added into the copper-containing wastewater and mixed to be uniform, and then 2 mL of DMF was added thereto. A resulting mixture was placed in a reactor and heated for 24 h at 80° C., and a resulting solid was dried for 24 h in a drying oven at 40° C., and then a dried product was ground to 9 μm to 18 μm to obtain the HKUST-1 (SO₃H).

### Example 3

Synthesis of HKUST-1 (SO₃H) (a Molar Ratio of the BTC to 5-SSIPA being 8:2):

4 mL of the strongly acidic copper-containing industrial wastewater was diluted with 26 mL of deionized water to obtain a copper-containing wastewater. 0.544 g of BTC and 0.1749 g of 5-SSIPA (a molar ratio of the BTC to 5-SSIPA being 8:2) were added into 30 mL of anhydrous ethanol (a volume ratio of the ethanol to diluted wastewater being 1:1), and then dissolved through ultrasound. After that, a resulting solution was added into the copper-containing wastewater and mixed to be uniform, and then 2 mL of DMF was added thereto. A resulting mixture was placed in a reactor and heated for 20 h at 80° C., and a resulting solid was dried for 24 h in a drying oven at 40° C., and then a dried product was ground to 9 μm to 18 μm to obtain the HKUST-1 (SO₃H).

### Example 4

Synthesis of HKUST-1 (SO₃H) (a Molar Ratio of the BTC to 5-SSIPA being 6:4):

4 mL of the strongly acidic copper-containing industrial wastewater was diluted with 26 mL of deionized water to obtain a copper-containing wastewater. 0.4085 g of BTC and 0.3502 g of 5-SSIPA (a molar ratio of the BTC to 5-SSIPA being 6:4) were added into 30 mL of anhydrous ethanol (a volume ratio of the ethanol to diluted wastewater being 1:1), and then dissolved through ultrasound. After that, a resulting solution was added into the copper-containing wastewater and mixed to be uniform, and then 2 mL of DMF was added thereto. A resulting mixture was placed in a reactor and heated for 20 h at 80° C., and a resulting solid was dried for 24 h in a drying oven at 40° C., and then a dried product was ground to 9 μm to 18 μm to obtain the HKUST-1 (SO₃H).

### Example 5

Synthesis of HKUST-1 (SO₃H) (a Molar Ratio of the BTC to 5-SSIPA being 4:6):

4 mL of the strongly acidic copper-containing industrial wastewater was diluted with 26 mL of deionized water to obtain a copper-containing wastewater. 0.2723 g of BTC and 0.5252 g of 5-SSIPA (a molar ratio of the BTC to 5-SSIPA being 4:6) were added into 30 mL of anhydrous ethanol (a volume ratio of the ethanol to diluted wastewater being 1:1), and then dissolved through ultrasound. After that, a resulting solution was added into the copper-containing wastewater and mixed to be uniform, and then 2 mL of DMF was added thereto. A resulting mixture was placed in a reactor and heated for 20 h at 80° C., and a resulting solid was dried for 24 h in a drying oven at 40° C., and then a dried product was ground to 9 μm to 18 μm to obtain the HKUST-1 (SO₃H).

### Example 6

Synthesis of HKUST-1 (SO₃H) (a Molar Ratio of the BTC to 5-SSIPA being 2:8):

4 mL of the strongly acidic copper-containing industrial wastewater was diluted with 26 mL of deionized water to obtain a copper-containing wastewater. 0.1362 g of BTC and 0.7003 g of 5-SSIPA (a molar ratio of the BTC to 5-SSIPA being 2:8) were added into 30 mL of anhydrous ethanol (a volume ratio of the ethanol to diluted wastewater being 1:1), and then dissolved through ultrasound. After that, a resulting solution was added into the copper-containing wastewater and mixed to be uniform, and then 2 mL of DMF was added thereto. A resulting mixture was placed in a reactor and heated for 20 h at 80° C., a resulting solid was dried for 24 h in a drying oven at 40° C., and then a dried product was ground to 9 μm to 18 μm to obtain the HKUST-1 (SO₃H).

### Test Example 1

### Characterization of the HKUST-1 (SO₃H)s Prepared in Examples 2 to 6:

### (1) X-Ray Diffraction (XRD)

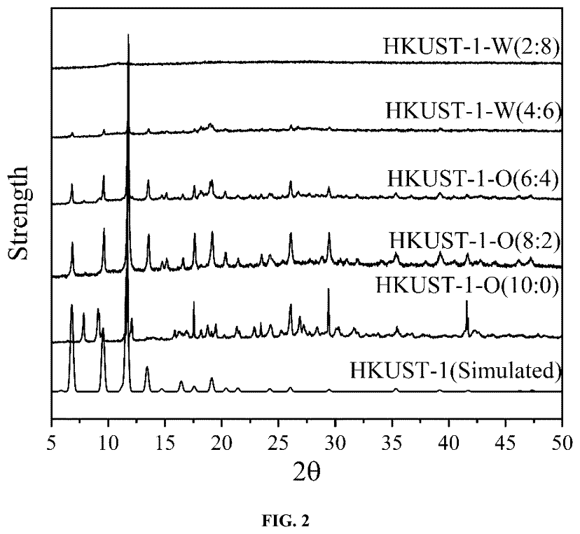

An XRD test was conducted on the HKUST-1 (SO₃H)s prepared in Examples 2 to 6, and the results are shown in FIG. 2. As shown in FIG. 2, the peaks of the HKUST-1 (SO₃H)s have similar positions to those of the simulated standard HKUST-1, proving that the HKUST-1 (SO₃H) has been successfully synthesized. In addition, as shown in FIG. 2, in terms of the crystallinity of HKUST-1 (SO₃H), the crystallinity of HKUST-1 (SO₃H) increases and then decreases with the increment of the proportion of 5-SSIPA ligand. When the molar ratio of BTC to 5-SSIPA is 8:2, the HKUST-1 (SO₃H) shows the maximum crystallinity and higher stability, indicating that the sulfonic acid group affects the structure of the HKUST-1 (SO₃H).

### (2) Fourier Transform Infrared Spectroscopy (FTIR)

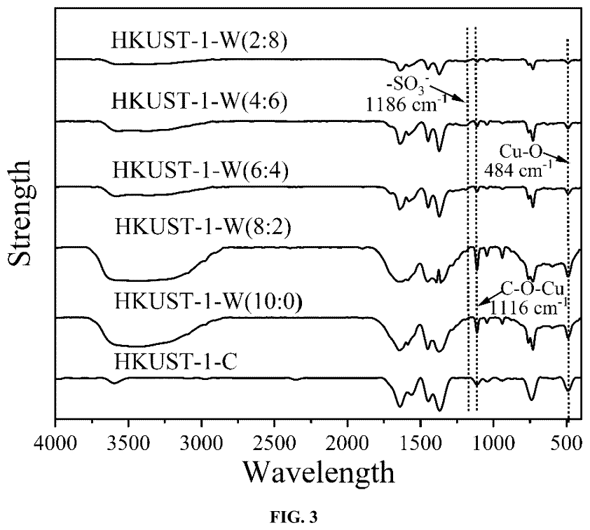

In order to further confirm that the HKUST-1 (SO₃H) was successfully synthesized in the present disclosure, infrared analysis was conducted on the HKUST-1 (SO₃H) prepared in Examples 2 to 6, and the results are shown in FIG. 3. As shown in FIG. 3, the HKUST-1 (SO₃H)s prepared in Examples 2 to 6 all show weak peaks at 490 cm⁻¹ and 950 cm⁻¹, which attribute to the stretching vibration of the Cu—O bond and the C—O—Cu bond, indicating that the copper ions are well introduced into HKUST-1. In addition, except for Example 2, the other examples all find a micro-peak of the S═O bond at 1,533 cm⁻¹, indicating that the HKUST-1 structure contains sulfonic acid groups, thus proving that the sulfonic acid groups have been successfully introduced into HKUST-1.

### (3) X-Ray Photoelectron Spectroscopy (XPS)

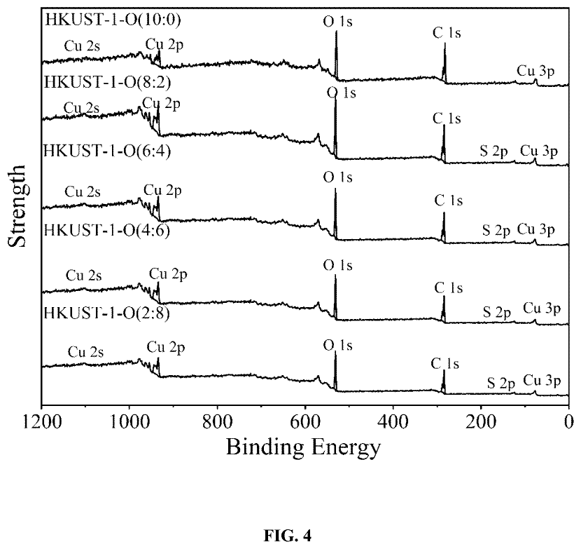

An XPS test was conducted on the HKUST-1 (SO₃H)s prepared in Examples 2 to 6, and the results are shown in FIG. 4. As shown in FIG. 4, the HKUST-1 (SO₃H)s prepared in Examples 2 to 6 all show a Cu₂ₚ peak at 932 eV, an O₁ₛ peak at 529 eV, and a C₁ₛ peak at 282 eV before adsorption. Moreover, after grafting with the 5-SSIPA, an S₂ₚ peak also appears at 77 eV, indicating that the sulfonic acid group was successfully introduced. In addition, the Cu₂ₚ peak height increases significantly after grafting with the sulfonic acid group, indicating that the HKUST-1 has a significant enhancement in chemical stability.

### (4) Adsorption Performance Test

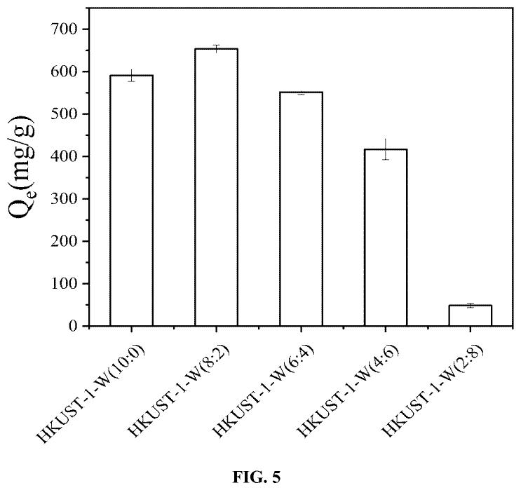

The HKUST-1 (SO₃H)s prepared in Examples 2 to 6 were subjected to an adsorption performance test. Under laboratory conditions, 1,000 mg/L lead-containing wastewater (25° C., pH=4) was simulated and subjected to isothermal adsorption. The results are shown in FIG. 5. As shown in FIG. 5, with an increment of the proportion of 5-SSIPA, the adsorption degree of lead by HKUST-1 (SO₃H) increases and then decreases, and reaches 670 mg/g when the molar ratio of BTC to 5-SSIPA is 8:2, and the adsorption performance for lead ions is the most outstanding.

By the above characterization and adsorption performance tests on the HKUST-1 (SO₃H)s prepared in Examples 2 to 6, it can be seen that the HKUST-1 (SO₃H) has been successfully synthesized, and shows a desirable adsorption performance and a high structural stability.

It can be seen from the above examples that the preparation method according to the present disclosure could synthesize the HKUST-1 (SO₃H) in one step, has simple preparation steps, and is easy to operate, allowing resource utilization of copper-containing wastewater and having a low production cost. The HKUST-1 (SO₃H) exhibits an excellent adsorption performance, a stable structure, and a high adsorption capacity, and could be further used for wastewater treatment.

Although the present disclosure is described in detail in conjunction with the foregoing examples, they are only a part of, not all of, the embodiments of the present disclosure. Other examples could be obtained based on these embodiments without creative efforts, and all of these embodiments shall fall within the scope of the present disclosure.

What is claimed is:

1. A method for preparing a sulfonic acid-functionalized copper metal-organic framework, comprising the following steps:
(1) providing a copper-containing wastewater with a copper ion concentration of not less than 6 g/L; and
(2) mixing the copper-containing wastewater, anhydrous ethanol, trimesic acid (BTC), 5-sulfoisophthalic acid monosodium salt (5-SSIPA), and N,N-dimethylformamide (DMF) to obtain a mixture, and subjecting the mixture to coordination polymerization to obtain the sulfonic acid-functionalized copper metal-organic framework.

2. The method according to claim 1, wherein the coordination polymerization is conducted at a temperature of 75° C. to 85° C. for 20 h to 24 h.

3. The method according to claim 1, wherein a molar ratio of the BTC to the 5-SSIPA is in a range of 2-10: 0-8, excluding 0.

4. The method according to claim 1, wherein a molar ratio of copper ions in the copper-containing wastewater to the BTC is in a range of 3.85-19.23:1.

5. The method according to claim 1, wherein the copper-containing wastewater has the copper ion concentration of not less than 15 g/L.

6. The method according to claim 1, wherein a volume ratio of the copper-containing wastewater to the anhydrous ethanol is in a range of 1: 1-1.5.

7. The method according to claim 1, wherein a volume ratio of the copper-containing wastewater to the DMF is in a range of 2-10: 1-3.

8. A sulfonic acid-functionalized copper metal-organic framework prepared by the method according to claim 1, having a molecular formula of C₁₈H₁₀O₁₆N₃Cu₃S.

9. The sulfonic acid-functionalized copper metal-organic framework according to claim 8, wherein the sulfonic acid-functionalized copper metal-organic framework has an average pore size of 9.2 nm to 10.61 nm.

10. A method of using the sulfonic acid-functionalized copper metal-organic framework according to claim 8, comprising using the sulfonic acid-functionalized copper metal-organic framework in waste resource treatment, gas adsorption and separation, dyes, and antibiotic degradation.

11. The method according to claim 3, wherein a molar ratio of copper ions in the copper-containing wastewater to the BTC is in a range of 3.85-19.23:1.

12. The method according to claim 6, wherein a volume ratio of the copper-containing wastewater to the DMF is in a range of 2-10: 1-3.

13. The sulfonic acid-functionalized copper metal-organic framework according to claim 8, wherein the coordination polymerization is conducted at a temperature of 75° C. to 85° C. for 20 h to 24 h.

14. The sulfonic acid-functionalized copper metal-organic framework according to claim 8, wherein a molar ratio of the BTC to the 5-SSIPA is in a range of 2-10: 0-8, excluding 0.

15. The sulfonic acid-functionalized copper metal-organic framework according to claim 8, wherein a molar ratio of copper ions in the copper-containing wastewater to the BTC is in a range of 3.85-19.23:1.

16. The sulfonic acid-functionalized copper metal-organic framework according to claim 8, wherein the copper-containing wastewater has the copper ion concentration of not less than 15 g/L.

17. The sulfonic acid-functionalized copper metal-organic framework according to claim 8, wherein a volume ratio of the copper-containing wastewater to the anhydrous ethanol is in a range of 1: 1-1.5.

18. The sulfonic acid-functionalized copper metal-organic framework according to claim 8, wherein a volume ratio of the copper-containing wastewater to the DMF is in a range of 2-10: 1-3.

19. The method according to claim 10, wherein the sulfonic acid-functionalized copper metal-organic framework has an average pore size of 9.2 nm to 10.61 nm.
